(19) United States
(12) Patent Application Publication
(10) Pub. No.: US 2013/0263713 A1
(43) Pub. Date: Oct. 10, 2013

(54) SHEET PUNCHER

(71) Applicant: Tung-Lung Chiang, Yunlin County (TW)

(72) Inventor: Tung-Lung Chiang, Yunlin County (TW)

(21) Appl. No.: 13/442,188

(22) Filed: Apr. 9, 2012

(51) Int. Cl. B26D 7/26; B26D 5/08; B26F 1/02

(52) U.S. Cl. 83/571

(57) ABSTRACT

A sheet puncher includes an accommodating space, two fulcrum members and a punching mechanism. The punching mechanism is replaceably received in the accommodating space, and the two fulcrum members flank the accommodating space. Each of the fulcrum members has a top. The punching mechanism has an immovable unit, two pivots and two pulling levers. The two pulling levers are coupled to the pivots, respectively. Each of the pulling levers has a handle segment and a pushing segment. The pulling lever can swing against the pivot. When the two handle segments are pulled away from a bottom of the accommodating space, the pushing segments press upon the tops of the fulcrum members so as to prop the punching mechanism upward and away from the bottom of the accommodating space.

### BACKGROUND OF THE INVENTION

1. Technical Field

The present invention relates to sheet punchers, and more particularly to a sheet puncher having a replaceable punching mechanism.

2. Description of Related Art

As known, a sheet puncher is a tool for opening aligned holes on a sheet or stacked sheets of paper or the like. Such a sheet puncher usually comprises a transmitting mechanism, a pressing member, an accommodating space and a punching mechanism. The transmitting mechanism serves to drive the pressing member and the punching mechanism, thereby making the punching mechanism punch. For versatile adaption, the sheet puncher is typically provided with plural punching mechanisms having different hole sizes and hole numbers for alternatively and replaceably installed into the accommodating space.

For instance, Taiwan Patent No. 1298669 has disclosed a sheet puncher that has a punching mechanism equipped with a handle, for allowing a user to pull the punching mechanism transversely out of an accommodating space so that a spare punching mechanism may be further installed into the accommodating space as a replacement. However, since the handle is provided at one end of the punching mechanism, when transversely pulled out, the punching mechanism tends to have its end far from the handle drooping and dangling by gravity. Thus, once the user forgets to use one hand to prop up the punching mechanism which the other hand of him/her is pulling out transversely, falling and impact may happen and cause dangerous accidents.

### SUMMARY OF THE INVENTION

The present invention provides a sheet puncher that comprises a transmitting mechanism, a pressing member, an accommodating space and a punching mechanism. The punching mechanism is replaceably installed in the accommodating space. The transmitting mechanism serves to drive the pressing member and the punching mechanism, thereby making the punching mechanism punch. The sheet puncher is characterized in further having a power source and two fulcrum members. The power source serves to drive the transmitting mechanism. The two fulcrum members are deposited to flank the accommodating space. Each of the fulcrum members has a top.

The punching mechanism comprises two pivots and two pulling levers. The two pivots are deposited at two sides of the punching mechanism and the two pulling levers are coupled to the pivots, respectively. Each of the pulling levers has a handle segment extending in a first direction, a pushing segment extending in a second direction, and an extended segment extended from the pushing segment. The pivot is coupled to the pulling lever between the handle segment and the pushing segment. The extended segment has a free end far from the handle segment. Each of the pulling levers is configured to swing against the pivot between a first position and a second position.

To operate, a user has to use his/her both hands to hold the two handle segments at the same time to turn the pulling levers to the first position where the pulling levers are far from the bottom of the accommodating space. Then the punching mechanism may be lifted out the accommodating space, allowing installation of another punching mechanism. This design requiring two-hand operation is effective in preventing a user from holding the punching mechanism with his/her single hand and thereby preventing falling and impact that endanger the safety of both the user and the mechanism.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a sheet puncher of the present invention;

FIG. 2 is a perspective view of the sheet puncher with its casing removed to clearly show inner components;

FIG. 3 is perspective view of a punching mechanism in the disclosed sheet puncher;

FIGS. 4 and 5 illustrate operation of the disclosed sheet puncher, particularly showing its transmitting mechanism, pressing member and punching mechanism;

FIG. 6 is a perspective view of the disclosed sheet puncher whose two lids are open;

FIGS. 7 and 8 illustrate operation of the punching mechanism of the disclosed sheet puncher; and

FIG. 9 is a perspective view of the disclosed sheet puncher showing the punching mechanism removed from the accommodating space.

### DETAILED DESCRIPTION OF THE INVENTION

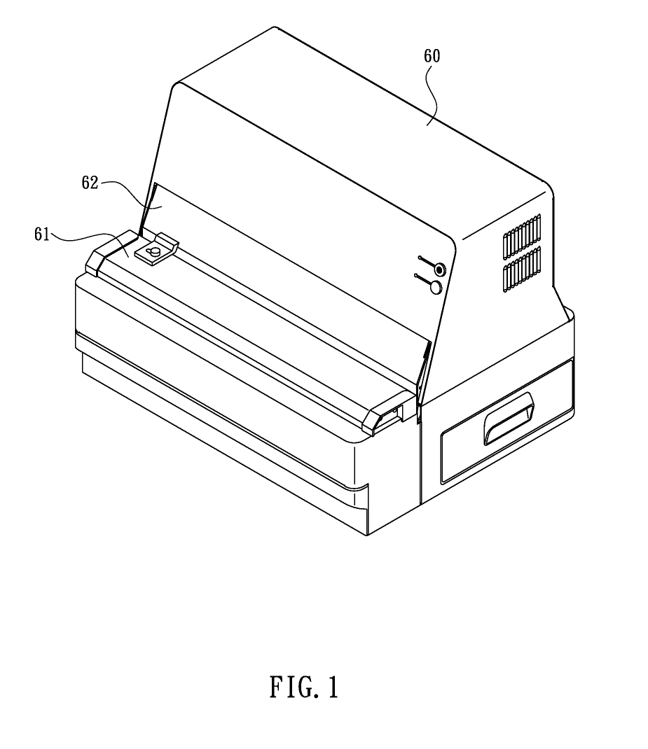

Referring to FIG. 1 through FIG. 4, according to one embodiment of the present invention, a sheet puncher for making holes is mainly composed of a power source 10, a transmitting mechanism 20, a pressing member 30, an accommodating space 40, two fulcrum members 41 and a punching mechanism 50. The sheet puncher further has a casing 60 for enclosing the above-recited components. The casing 60 may be provided with lid members 61, 62 that may be open or closed to each other for selectively exposing the accommodating space 40 or the punching mechanism 50. The power source 10 serves to drive the transmitting mechanism 20 that further drives the pressing member 30 to activate the punching mechanism 50 to punch. The transmitting mechanism is transmissively coupled to the pressing member 30 directly or through other components. In the present embodiment, each of the two fulcrum members 41 is connected between the transmitting mechanism 20 and the pressing member 30, so that the transmitting mechanism 20 is transmissively coupled to the pressing member 30 indirectly. In addition, the punching mechanism 50 is removably installed in the accommodating space 40 and may be replaced by a spare punching mechanism for meeting practical needs.

In the present embodiment, the power source 10 is a motor that has an output shaft 11 and a gear 12 mounted around the output shaft 11. For providing greater torque or for other purposes, the power source 10 may further comprise a reducing mechanism (not shown). In other embodiments, the power source may be provided by a user who is manually driving the transmitting mechanism 20.

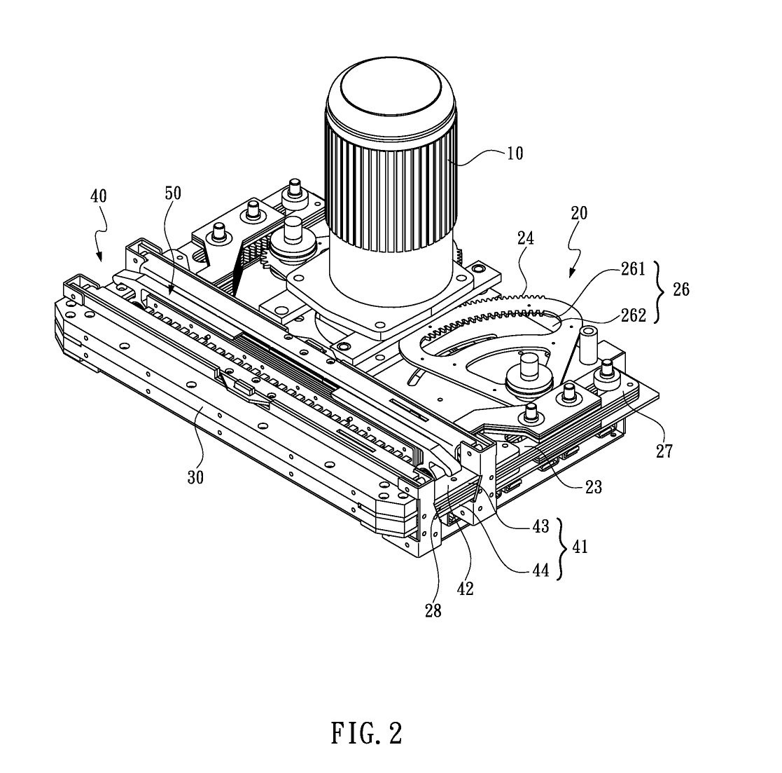

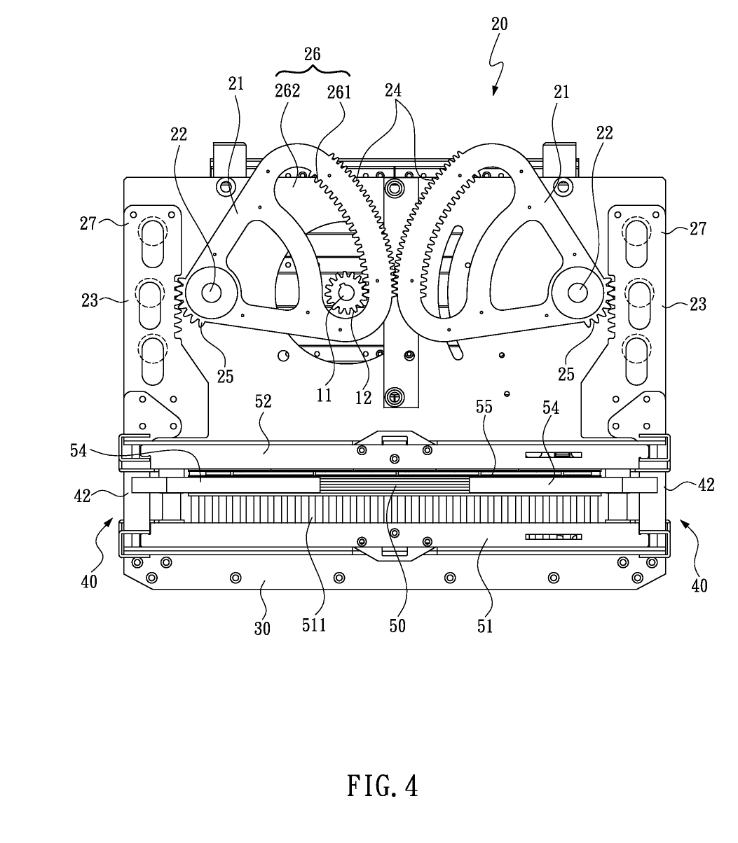

As can be seen in FIGS. 2 and 4, the transmitting mechanism 20 includes two drive gears 21, two gear shafts 22 and two driven bars 23. The two drive gears 21 are rotatably mounted around the two gear shafts 22, respectively. Each of the drive gears 21 has a first toothed portion 24, a second toothed portion 25 and a third toothed portion 26. The first toothed portions 24 of the two drive gears 21 are engaged with each other so that the two drive gears 21 are transmissive to each other. Each of the driven bars 23 has a toothed end 27 and a connecting end 28. The toothed ends 27 of the two driven bars 23 are engaged with the second toothed portions 25 of the two drive gears 21, respectively. The connecting ends 28 of the two driven bars 23 are directly or indirectly coupled to the pressing member 30. For example, the connecting ends 28 and the pressing member 30 may be connected through the respective fulcrum members 41. The third toothed portion 26 may be an arched hole 262 partially defined by teeth 261, and the third toothed portion 26 of one of the drive gears 21 is engaged with the gear 12 mounted around the output shaft 11.

Referring to FIGS. 2 and 4, the two fulcrum members flank the accommodating space 40. In the present embodiment, each of the fulcrum members 41 is composed of an upper piece 43 and a lower piece 44, and each of the driven bars 23 is partially sandwiched between the corresponding pieces 43, 44. The two pieces 43, 44 are further coupled to the pressing member 30 so that the driven bars 23, the fulcrum members 41 and the pressing member 30 are transmissively connected. Furthermore, each of the fulcrum members 41 has a top 42. In the present embodiment, the top 42 refers to the upper surface of the upper piece 43. Alternatively, in other embodiments, the two fulcrum members 41 may be provided as independent parts fixed inside the casing 60 or the system, without moving with the driven bars 23 or the pressing member 30.

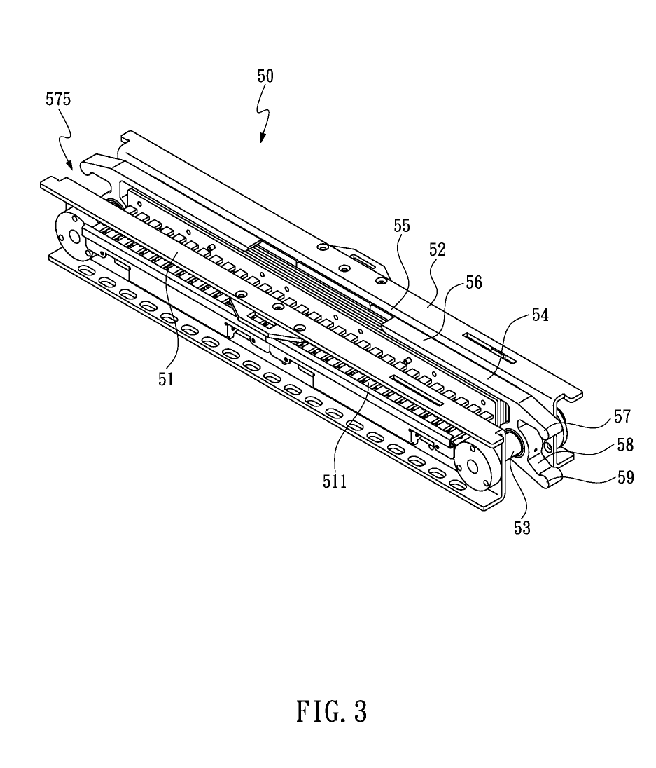

Referring to FIGS. 3 and 4, the punching mechanism 50 includes a movable unit 51, an immovable unit 52, two pivots 53 and two pulling levers 54. The immovable unit 52 has a gap 55 for receiving a sheet or a stack of sheets to be punched. The movable unit 51 has a plurality of boring tools 511 and is driven by the pressing member 30 to slide on the pivots 53 toward or away from the immovable unit 52. When the movable unit 51 approaches the immovable unit 52, the boring tools 511 enter the gap 55 to bore the sheet or the stack of sheets placed in the gap 55. The two pivots 53 are deposited at two sides of the immovable unit 52, and the two pulling levers 54 are mounted around the pivots 53, respectively, so that the pulling levers 54 are allowed to swing against the pivots 53 between a first position and a second position. Basing on the pivots 53, each of the pulling levers 54 has a handle segment 56 extending in a first direction and a pushing segment 57 extending in a second direction. The first and second directions may be opposite to each other to have the pivot 53 located between the handle segment 56 and the pushing segment 57. Preferably, the pulling lever 54 further has an extended segment 58 that is in the proximity of the pushing segment 57 and comprises a free end 59 far away from the handle segment 56. In addition, a notch 575 is defined between the extended segment 58 and the pushing segment 57.

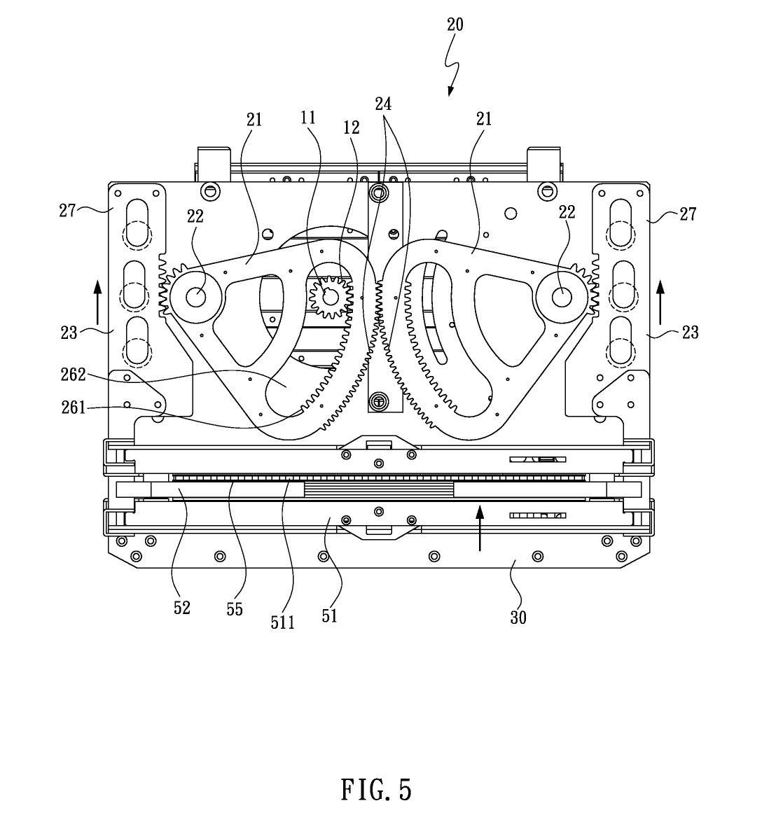

Referring to FIGS. 2, 4 and 5, the power supplied by the power source 10 is transmitted to one of the drive gears 21 through the output shaft 11. Since the two drive gears 21 are transmissive to each other, the two driven bars 23 can be driven by the two drive gears 21 synchronously so as to displace the pressing member 30. Then the movable unit 51 is pushed by the pressing member 30 toward the immovable unit 52 to bore the sheet or sheets placed in the gap 55.

The following description will be directed to the replacement of the punching mechanism.

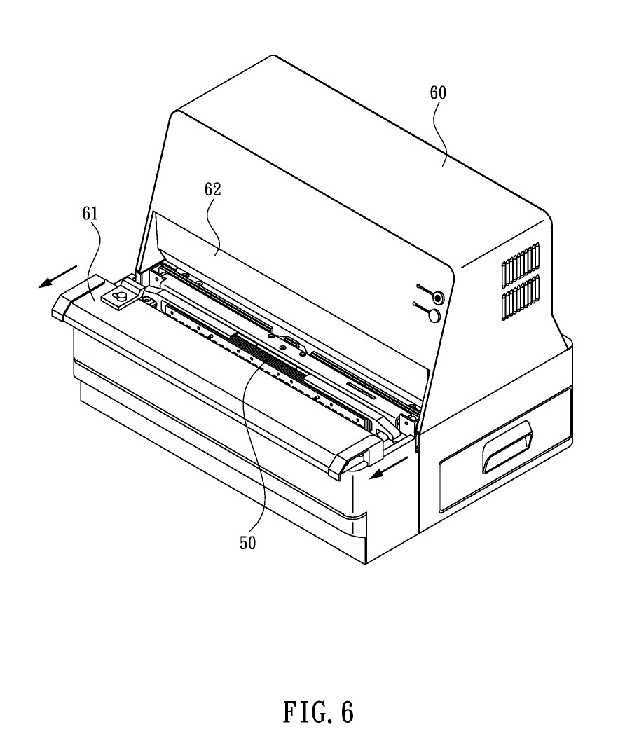

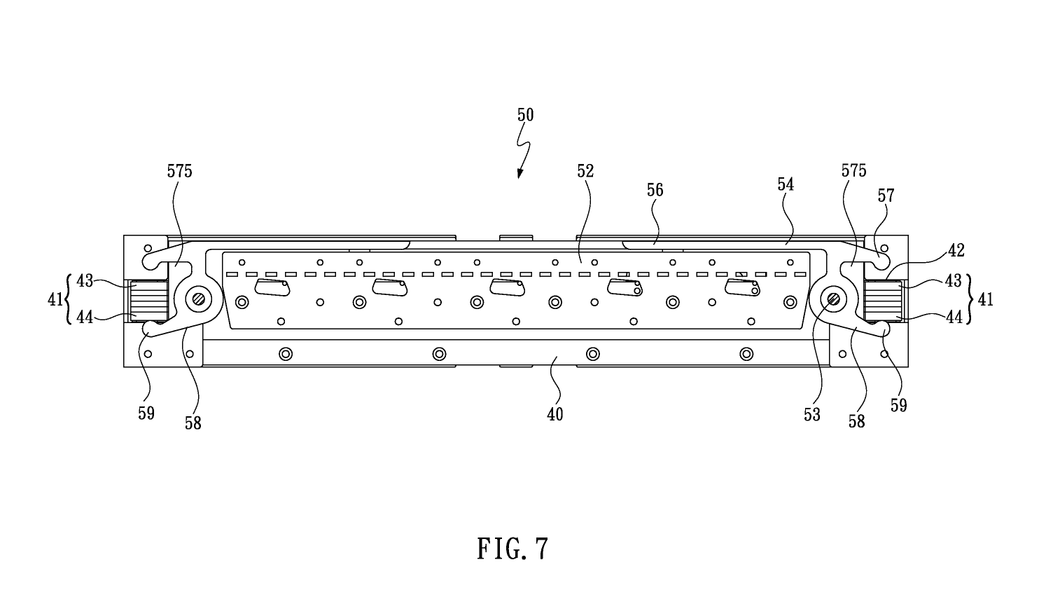

As shown in FIG. 6, the lid members 61, 62 of the casing 60 are first opened to make the punching mechanism 50 accessible from outside. At this time, the punching mechanism 50 is in its second position, as shown in FIG. 7, with the handle segments 56 being close to the immovable unit 52, the pushing segments 57 isolating from the fulcrum members 41 so that the punching mechanism 50 is deep down in the accommodating space 40 at a second depth. The free ends 59 of the two extended segments 58 are below the fulcrum members 41, with the fulcrum member 41 received in the notches 575. Therein, the distance between the two free ends 59 is greater than the distance between the two fulcrum members 41 so as to prevent the punching mechanism 50 from escaping from the accommodating space 40.

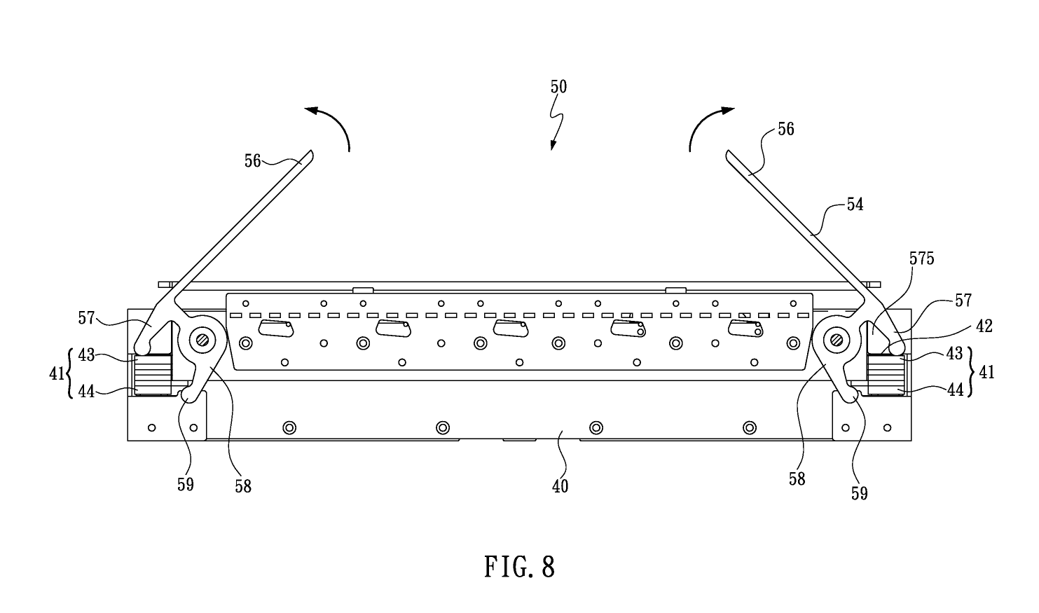

Referring to FIG. 8, for replacing the currently installed punching mechanism 50, a user may hold and pull the handle segments 56 away from the immovable unit 52 and the bottom of the accommodating space 40 so as to lift the pulling levers 54 to the first position. At this time, the pushing segments 57 are pressing upon the tops 42 of the fulcrum members 41, and the punching mechanism 50 is now at a first depth in the accommodating space 40. The first depth is smaller than the second depth based on the total depth of the accommodating space 40. Presently, the two extended segments 58 are drawn toward each other and the distance between the two free ends 59 becomes smaller than the distance between the two fulcrum members 41, thereby allowing the punching mechanism 50 to be releasable from the accommodating space 40.

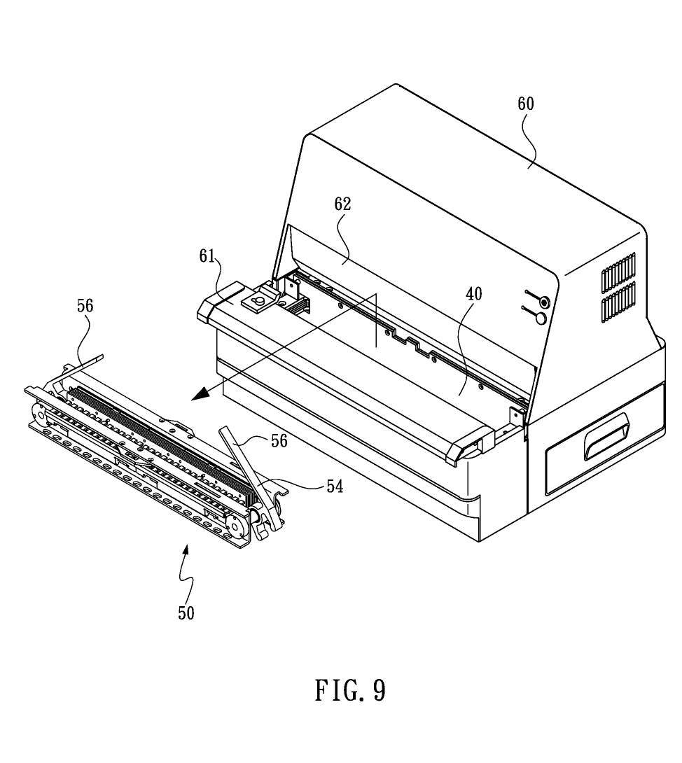

At last, as shown in FIG. 9, the user may use his/her both hands to hold the two handle segments 56 and pull the punching mechanism 50 out of the accommodating space 40 for replacement or repair.

With the two pulling levers, when pulling out the punching mechanism, the user has to hold the both pulling levers with his/her two hands to make the punching mechanism get supported at two sides thereof so as to ensure operational safety. Also, by pulling the handle segments upward, the punching mechanism can be lifted from the second depth to the first depth, and the free ends of the extended segments are displaced from the positions below the fulcrum members, allowing the punching mechanism to be further lifted from the accommodating space, so as to facilitate replacement. Moreover, after the replacement punching mechanism is installed, and the pulling levers are at the second position, the free ends of the extended segments are below the fulcrum members again to prevent the punching mechanism from escaping from the accommodating space.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A sheet puncher, comprising a transmitting mechanism, a pressing member, an accommodating space and a punching mechanism, the punching mechanism being replaceably received in the accommodating space, and the transmitting mechanism driving the pressing member and the punching mechanism to make the punching mechanism punch, the sheet puncher being characterized in:
the sheet puncher further comprising two fulcrum members flanking the accommodating space, each said fulcrum member having a top, the punching mechanism including two pivots and two pulling levers, the two pivots being deposited at two sides of the punching mechanism, the two pulling levers being coupled to the pivots, respectively, each said pulling lever having a handle segment extending in a first direction, a pushing segment extending in a second direction and an extended segment being close to the pushing segment, the pivot being located between the handle segment and the pushing segment, the extended segment having a free end far away from the handle segment, and the pulling lever being configured to swing against the pivot between a first position and a second position.

2. The sheet puncher of claim 1, wherein when the handle segments are pulled up and away from a bottom of the accommodating space, the pulling levers are at a first position, in which the pushing segments prop the tops of the fulcrum members, and the extended segments of the two pulling levers come close to each other, while a distance between the two free ends is smaller than a distance between the two fulcrum members.

3. The sheet puncher of claim 1, wherein when the pulling levers are at the second position, the handle segments are relatively close to the punching mechanism, and the pushing segments are isolated from the fulcrum members, while the free ends of the extended segment are located below the fulcrum members, in which a distance between the two free ends is greater than a distance between the two fulcrum members.

4. The sheet puncher of claim 1, wherein the sheet puncher further comprises a power source for driving the transmitting mechanism.

5. The sheet puncher of claim 1, wherein the transmitting mechanism comprises two drive gears, two gear shafts and two driven bars, the two drive gears being rotatably mounted around the two gear shafts, respectively, each said drive gear having a first toothed portion and a second toothed portion, the first toothed portions of the two drive gears being engaged with each other, each said driven bar having a toothed end and a connecting end, the toothed ends of the two driven bars being engaged with the second toothed portions of the two drive gears, respectively, and the connecting ends of the two driven bars being coupled to the pressing member.

6. The sheet puncher of claim 5, wherein the power source has an output shaft, and one of the two drive gears has a third toothed portion, so that the third toothed portion and the output shaft are engaged with each other.

7. The sheet puncher of claim 1, wherein the punching mechanism further comprises a movable unit and an immovable unit, the immovable unit including a gap for receiving a sheet or sheets to be punched, and the movable unit being driven by the pressing member to selectively come close to the immovable unit for boring the sheet or sheets or leave from the immovable unit for releasing the sheet or sheets.
